(19) United States
(12) Patent Application Publication
(10) Pub. No.: US 2017/0058453 A1
(43) Pub. Date: Mar. 2, 2017

(54) FABRIC PRETREATMENT FOR DIGITAL PRINTING

(71) Applicant: Lubrizol Advanced Materials, Inc., Cleveland, OH (US)

(72) Inventors: Yun-Long Pan, Cincinnati, OH (US); Stacy L. Rohde, North Olmsted, OH (US); Gary A. Anderle, North Olmsted, OH (US)

(21) Appl. No.: 15/119,864

(22) PCT Filed: Feb. 16, 2015
(86) PCT No.: PCT/US2015/015997

§ 371 Date: Aug. 18, 2016

Related U.S. Application Data
(60) Provisional application No. 61/946,041, filed on Feb. 28, 2014.

(51) Int. Cl. D06P 5/00; B41J 3/407; D06P 1/52; D06P 5/30; D06P 5/20

(52) U.S. Cl. CPC D06P 5/002; D06P 5/30; D06P 5/2072; D06P 1/5257; B41J 3/4078

(57) ABSTRACT

An aqueous polymer dispersion with nonionic colloidal stabilization, polyvalent metal ion, coagulating acid, and an optional mono or polyhydric alcohols and/or alkylene-oxide oligomers (humectants or surface tension modifiers), and optional surfactant are disclosed for use as pretreatment for substrates such as textiles and garments.

### FIELD OF INVENTION

The invention relates to a substrate pre-treatment for digital printing derived from a nonionic polymer dispersed in water, a polyvalent water soluble metal, coagulating acidic additives, and optionally a reactive crosslinking agent. The performance of the pretreatment is enhanced over prior pretreatments by a coagulating acidic additive; and the adhesion to substrate and image wash resistance are improved by heating the ink images to optimal temperatures and optionally by a reactive crosslinking moiety. Such pre-treatments are useful in various ink receptive applications, including digital and/or textile printing.

### BACKGROUND OF THE INVENTION

Digital printing, including inkjet, is a method of reproducing an image or data onto a medium directly from a computer, typically on conventional substrates. When the ink is applied onto the media, it should stay at or near the substrate surface in a tight, symmetrical dot; otherwise the dots of the ink will begin to penetrate into the receiving media, feather, or spread out in an irregular fashion to cover a slightly larger area than the digital printer designer intended. The result is an image or data that appears to have low color intensity, fuzziness, especially at the edges of objects and text, etc. The ink and/or pigment may also penetrate the fiber yielding less colorful images and create discoloration on the backside of a fabric.

EP 1 924 658 to E.I. Du Pont de Nemours describes an aqueous vehicle (ink) having dispersed therein titanium dioxide pigment dispersed with a polymeric dispersant and a crosslinked polyurethane binder additive (different from the polymeric dispersant). The white ink was deemed especially useful for printing images on non-white textiles.

US 2008/0092309 A1 to E.I. Du Pont de Nemours describe an aqueous inkjet printing pretreatment comprising a nonionic latex polymer and a multivalent cationic salt.

US 2007/0103528 to Kornit relates to an ink for digitally printing to produce high-quality and durable abrasion-fast image which will not deteriorate in washes or be harsh to the touch and brittle.

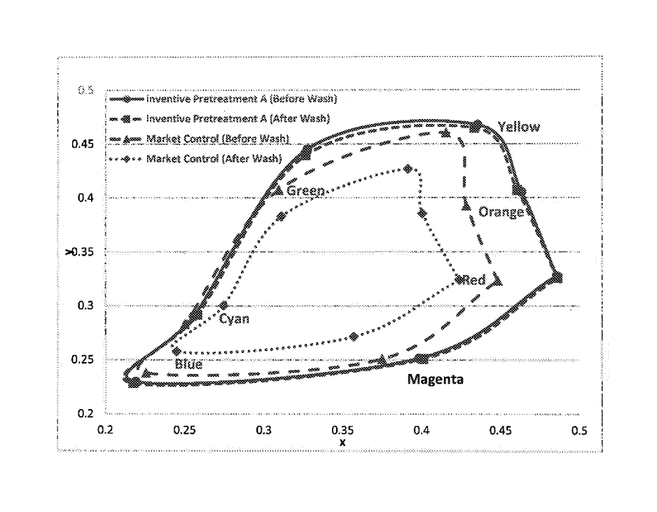

EP 1 356 155 to Kimberly-Clark Worldwide, Inc. relates to a cationic polymer coating formulation for ink jet printing used in conjunction with imbibing solutions. The imbibing solutions can be urea (for acid dye-based ink) or ammonium salts such as ammonium oxalate and ammonium tartrate. In one embodiment, the formulation includes 5-95% cationic polymers or copolymers and from about 5-20% fabric softeners. The cationic polymers are shown in FIGS. 1A-1C of the reference and appear to be free radically polymerized polymers such as from diallyl ammonium monomers.

EP 1 240 383 to Kimberly Clark Worldwide, Inc. relates to coating formulation improvements including imbibing solutions for treating substrates such as cationic polymers or copolymers and fabric softeners. It also describes polymeric latex binders to increase washfastness.

EP 2 388 371 A1 to Brother Kogyo Kabushiki Kaisha discloses a method for forming an image on a fabric including pretreatment and a heat fixing step, wherein the pretreatment comprises a diallyldimethylammonium chloride-sulfur dioxide copolymer and a mixture of allyamine-diallyamine copolymer and sodium chloride.

The above references teach different ways to improve properties of images on various backgrounds. Some call for cationic polymers, some call for fabric softeners, some call for crosslinked particles, some recite titanium dioxide pigments while others use reactive dyes. They all seem to seek soft-feel images on textiles that have good color intensity, crisp well defined images, and good retention of color during mechanical washing of the textiles.

### SUMMARY OF THE INVENTION

The present invention is directed towards substrate pretreatment composition comprising an aqueous nonionic polymer dispersed in water, a polyvalent metal (typically in the water soluble salt form), a coagulating acid, and optionally a reactive crosslinking agent. The pre-treatment is desirably applied to fabric substrates. In one embodiment, a preferred fabric substrate is dark colored fabric substrates where a white intermediate ink layer is often applied to create a highly opaque surface with high whiteness on the fabric to enhance color intensity of subsequently applied colored inks. The pre-treatment facilitates the generation of intense colored images derived from water based white or colored inks on fabrics and the ability to retain the color intensity after multiple laundry cycles or other washing procedures. Preferred ink printing processes include digital or ink jet printing but the pretreatment works substantially similarly on older transfer printing processes such as flexo, roto gravure, offset and screen printing. Preferred inks to use with the pretreatment include pigmented inks although since the pre-treatment helps optimize ink location and adhesion it can work with inks relying on dyes. The pretreatment helps promote adhesion of printed ink images on textiles and thus helps maintain the color intensity of the images after multiple laundry cycles.

The pretreatment composition comprises a nonionic polymer dispersion in aqueous media, a polyvalent metal, and an acid. The polyvalent metal and/or its salt in the pretreatment facilitate coagulating subsequently applied inks near the surface of the fabric where the color intensity from the ink will be maximized. The act of coagulating the ink pigment and or binder helps prevent bleeding or migration of the subsequently applied ink to other areas of the fabric where the ink wasn't supposed to be and where the colored intensity from the ink is not optimized.

The coating composition also includes a water soluble (desirably water soluble at concentrations of 10 g/l or more, more desirably 25 g/l or more, and preferably 50 g/l or more at 25° C.) acid component selected from inorganic and organic acids such as phosphoric acid, AlCl₃ or their derivatives or a carboxylic acid or combinations thereof. These water soluble acids will be called coagulation acids as their function is to help coagulate a anionic colloidally stabilized inks applied over the pretreatment. They may include Brönsted and/or Lewis acids such as AlCl₃. The coagulating acid, if organic, can have one or more carboxylic acid groups. If organic it generally has from 1 to 20 carbon atoms, and more preferably from 1 to 10 carbon atoms. Preferred organic coagulating acids include formic, acetic, citric, tartaric, itaconic, and oxalic acids. Preferred inorganic acids include AlCl₃, AlCl₃ derivatives, phosphoric acids, and phosphoric acid derivatives. Without being bound by theory, AlCl₃ generates HCl when added to water.

Fabric and garment pretreatments generally need to be clear or translucent coatings so they can be applied over a wide variety of different colored substrates. The pretreatment is often applied to a slightly larger area on the textile or garment than the subsequently applied image. If the substrate is a dark color, the pretreatment desirably helps the later applied digital inks (especially white ink) become an opaque layer (optimizing color intensity and minimizing substrate contribution to colors) with minimal ink thickness. The pretreatment and digitally applied ink need to provide wear resistance to a final digital image while the garment is worn, subjected to abrasive contact with other fabrics (such as while cleaned in a washing machine), or comes in frictional or abrasive contact with floors, walls, carpet, etc. The pretreatment and digital ink image desirably neither change the softness, flexibility, feel, etc., of the image area of the fabric or garment nor cause puckering of the fabric or garment due to different shrinkage rates in the image and non-image portion of the substrate. Most coatings (especially crosslinked coatings, which tend to be more durable) on textiles make the textile stiffer (less soft). It is desired to minimally decrease the softness or hand of the fabric by the pretreatment and subsequently applied ink image, which is difficult.

### BRIEF DESCRIPTION OF THE DRAWING

The attached drawing illustrates the Chromaticity Diagram from CIE 1976 L*, a*, b* color space scale as measured by a colorimetric meter made by X-Rite Gretagmacbeth (Model# Color i7) on a digitally printed image on top of either a) a commercial direct to garment pretreatment or b) the inventive pretreatment of this disclosure.

### DETAILED DESCRIPTION OF THE INVENTION

### Polymer in Dispersed Form Colloidally Stabilized by Nonionic Mechanism

The pretreatments for textile substrate include a polymer dispersed in an aqueous media by nonionic colloidal stabilizers. Nonionic stabilization is indicated because anionic stabilization would be severely compromised by the polyvalent metals and acid component. These polymer dispersions can be emulsions and/or dispersions and can include some ionic stabilizers (such as anionic or cationic) as long as there is sufficient nonionic stabilization of the dispersed polymer that it doesn't coagulate in the presence of the polyvalent metal and/or acid components. It has been found that pretreated textiles including a nonionic latex polymer provide high color density and saturation relative to untreated textiles, superior print quality relative to untreated textiles, and reduction of wicking or bleeding relative to untreated textiles, and enhanced adhesion between the image and the textile. The pretreatment desirably provide a more wash fast printed image.

The polymer of the pretreatment can be a variety of synthetic polymers or polymer blends such as urethane polymer; polymers from vinyl acetate, ethylene, acrylate, acrylamide, styrene, and blends of said monomers and/or polymers. One or more nonionically stabilized polymers may be used in the pretreatment solution. In one embodiment, it is desirable that the Tg (glass transition temperature) of the polymer(s) is less than 20° C., more desirably less than 10° C., and preferably less than 0° C. so that the polymer binder does not make the treated fabric stiffer and reduce softness of the fabric in the area of the image.

The pretreatment polymer, colloidally stabilized nonionically, must be colloidally stable to the polyvalent metal and coagulating acid. If the nonionic polymer dispersion or latex gels or it is not colloidally stable in the presence of the polyvalent metal solution, then it cannot be used as a pre-treatment binder. A screening test for whether a nonionic polymer forms a colloidally stable dispersion or latex in the presence of the multivalent cationic salt solution is to mix a 10 wt. % polymer (on a dry basis) and a 15 wt. % of calcium nitrate or calcium chloride tetrahydrate and observe whether the dispersion is stable. The stability is observed at ambient temperature (25° C.) and after 10 minutes and 24 hours. The nonionic component of the polymer dispersion or latex must lead to a stable nonionic dispersion or latex with the polyvalent metal and the coagulating acid. In this context, stable means that at least 95 wt. % of the polymer of the dispersion stays dispersed after being exposed to the polyvalent metal as set forth above.

The nonionic component of the polymer can come from the incorporation of a nonionic reactant into the polymer dispersion. Examples of nonionic components include, ethylene oxide derivatives, acrylamide, methylol acrylamide, hydroxyethyl-substituted monomers, vinylpyrrolidone, ethyleneimines and the like. The incorporation of the nonionic component into the polymer dispersion can occur before, during, and/or after the polymerization step, which prepares the polymer dispersion. In the case of an ethylene oxide nonionic component, the substitution can take the form of incorporating a glycol with sufficient (—CH₂—CH₂O—)ₙ units to impart the nonionic stability. For instance, a polyurethane may have an alkyl polyethylene glycol incorporated into the nonionic polyurethane. The nonionic component can be the main component in nonionic polymer dispersion, as long as its properties satisfy the stability test described above.

The nonionic latex polymer may also have ionic components incorporated into the polymer. By example, for the polyurethanes ionic components such as acids may be used in the polyurethane reaction and a specific acid example is dimethylolpropionic acid. For the acrylamide and hydroxyethyl substituted nonionic polymer dispersions, the ionic source can be from (meth)acrylic acids, phosphorus containing initiator fragments, and conventional anionic surfactants. There are limits to the amount of ionic components in the nonionic latex polymer, since the nonionic components may complex with the multivalent cationic species and form a complex that will lead to instability of the nonionic latex polymer/multivalent cationic solution. The balance of nonionic and ionic components must lead to a stable solution as described above.

By example, in the case of a polyurethane nonionic latex polymer the nonionic content must be at least about 15 milliequivalents of ethylene oxide units incorporated into each gram of polyurethane, or in the case of the polyurethane preferably at least about 25 milliequivalents/gram where the milliequivalent/gram calculation is based on the dry polymer weight. In the polyurethane nonionic polymer dispersion, the ionic component can be less than about 10 milliequivalents/gram.

The solution should comprise sufficient nonionic polymer content and other ingredients to provide adequate infusion and/or coating of the textile and its surface fibers with the nonionically stabilized polymer dispersion. Typically, the pretreatment will comprise at least about 0.5 or 1 wt. % of the polymer and up to 30 wt. % of the polymer, and amounts can be used up to the solution/emulsion stability of the particularly nonionically stabilized polymer dispersion. Preferably, the pretreatment will comprise from about 1 or 2 wt. % to about 20 wt. % and more preferably about 1, 3 or 4 to about 10 or 15 wt. % of the polymer(s).

Urethane polymer dispersions nonionically stabilized as dispersions for use in a pretreatment with divalent or polyvalent metals are taught and exemplified in US 2010/0091052. Acrylate polymers nonionically colloidally stabilized include PrintRite® DP760 available from The Lubrizol Corporation and exemplified in the current examples. Other commercial acrylate polymers available as dispersions could also be used in the pretreatment provided they are nonionically colloidally stabilized and can remain dispersed after treatment with divalent metal ions as previously disclosed. Hybrids of urethane and acrylate polymers are also viable as the polymer nonionically stabilized as a dispersion in a pretreatment.

Some other properties of PrintRite® DP760 latex are worth mentioning as beneficial in a textile pretreatment prior to printing with an image. PrintRite® DP760 latex is a heat reactive acrylic latex (meaning it has a reactant that provides some crosslinking when exposed to heat) which may be methylol-acrylamide. Using a heat reactive polymer in a pretreatment enables one to reduce the swelling and softening of a polymer binder after it has been applied to a substrate. PrintRite® DP760 latex has good colloidal stability to addition of metal salts such as required in this specification. PrintRite® DP760 latex has a large particle size (about 200-400 nm in diameter) for an acrylate latex. It is known in the industry that there is an inverse correlation between particle diameter size and the amount of surface area stabilized by a surface active agent (such as nonionic stabilization). As the particle diameter increases, the surface area per gram of polymer decreases and the amount of surface active agent per gram of polymer decreases. PrintRite® DP760 latex has an ultimate tensile strength of 1100 psi (about 7.6 N/mm²), elongation to break of about 700-1000%, 50 wt. % solids, pH of 3.8, Tg of −10 to −15° C., and resistance to water and many solvents. The resistance to water and other solvents can be measured by forming a film of the polymer and then immersing the polymer film in water or the solvent to be tested.

It would be desirable for the polymer used as the binder of the pretreatment when formed into a film to have an elongation to break of at least 100 or 200% to about 1100%, ultimate tensile strength of 5 to 20 N/mm² (725-7250 lbs/in²), and swelling in water at 25° C. immersion for 24 hours of less than 100%. These physical properties would mean that the polymer would have properties indicating that it is somewhat soft (good elongation), has some tensile strength, and does not swell too much in water. These properties would allow it to form a tough and water resistant interlayer binding the ink image to the fibers of the fabric.

### Multivalent Metal Cation

The pretreatments of this invention comprise one or more polyvalent metal cations. The effective amounts needed in a particular situation can vary, and some adjustment, as provided for herein, will generally be necessary. “Polyvalent” indicates an oxidation state of two or more and, for an element “Z”, are typically described as Z²⁺, Z³⁺, Z⁴⁺ and so forth. For brevity, multivalent cations may be referred to herein as Z^{x}. The multivalent cations are substantially soluble in the aqueous pretreatment solution and preferably exist (in solution) in a substantially ionized state so that they are in a form where they are free and available to interact with textile when the textile is exposed to the pretreatment solution.

Z^{x} includes, but is not limited to polyvalent cations of the following elements of rows 2 to 12 of the common or standard form Periodic table where row 2 represents the alkaline earth metals and rows 3 to 12 represent the elements where the d orbitals are being filled, rows 12-18 represent the elements where the p orbitals are generally being filled, and the lanthanides and actinides (87-118) elements are in a separate rows below. In another embodiment, the multivalent cation comprises at least one of Ca, Mg, Ba, Ru, Co, Zn and Ga. Preferably the multivalent cation is Ca²⁺.

Z^{x} can be incorporated into pretreatment solution by addition in a salt form or by addition in an alkaline form and used as a base in the adjustment of the pretreatment solution pH.

In one embodiment, the pretreatment metals are water soluble polyvalent metal salts. For the purpose of this disclosure, water soluble will be defined as having solubility of the metal cation (not the salt) in water at 25° C. of at least 10 g/l, more desirably at least 25 g/l and preferably at least 50 g/l. Some metal salts might be colored species that may discolor and they would be less preferred in pretreatments for light colored garments. Iron chloride is one metal salt that is slightly colored. In the pretreatment it is preferred that the metal salts be selected from water soluble salts of calcium, magnesium, zinc, and zirconium. The preferred counterion (provided it provides water soluble salts include nitrate, sulfate, acetate, and chloride). Preferred oxidation states for the above listed metal cations are Ca²⁺, Mg²⁺, and Zn²⁺. Preferred amounts of the polyvalent metal (measured as the weight of the metal ions only and not the salt) are desirably from about 0.1 or 0.2 to about 15 wt. % of the pretreatment solution, more desirably from about 0.1 or 0.2 to about 8 wt. %, and preferably from about 0.5 to about 5 wt. % of the pretreatment solution. The water soluble polyvalent metals help promote color intensity in subsequently applied ink applications to the pretreatment by colloidally destabilizing subsequently applied ink dispersions.

The associated anionic counter ions can be chosen from any common anionic material, especially halides, nitrates and sulfates. The anionic form is chosen so that the multivalent cation is soluble in the aqueous pretreatment solution. The polyvalent cationic salts can be used in their hydrated form. One or more polyvalent cationic salts may be used in the pretreatment solution.

Calcium is a preferred polyvalent metal ion. For Ca, the preferred multivalent cation salts are calcium chloride, calcium nitrate, calcium nitrate hydrate and mixtures thereof.

### Coagulating Acids

The coating composition also includes a water soluble (desirably water soluble at concentrations of 10 g/l or more, more desirably 25 g/l or more, and preferably 50 or 100 g/l or more at 25° C.) acid component selected from inorganic, e.g. hydrochloric, phosphoric, and Brönsted and Lewis acids, such AlCl₃ and FeCl₃, and organic acids such as mono or poly carboxylic acids, or combinations thereof. These water soluble acids will be called coagulation and/or flocculation acids as their function is to help coagulate and/or flocculate subsequently applied anionic colloidally stabilized inks applied over the pretreatment. The coagulation and/or flocculation effect of acids is slightly different and supplemental to the coagulation effect of polyvalent metal ions on the anionically stabilized binders and pigments in inks. The coagulating acid, if organic, can have one or more carboxylic acid groups. It generally has from 1 to 20 carbon atoms and 1 to 4 acid groups, and more preferably from 1 to 10 carbon atoms. Preferred organic coagulating acids include formic, acetic, citric, tartaric, itaconic, and oxalic acids. Preferred inorganic acids include AlCl₃, AlCl₃ derivatives in aqueous media, phosphoric acids, and phosphoric acid derivatives in aqueous media. Without being bound by theory, AlCl₃ generates HCl and forms various aluminium hydroxides when added to water. The coagulating acid is typically present in amounts from about 0.1 to 10 wt. % based on the weight of the pretreatment solution, more desirably from about 0.1 or 0.2 to about 8 wt. %, and preferably from about 0.1 or 0.2 to about 5 wt. %. Desirably, the acid component is also used in a sufficient amount to adjust the pH of the pretreatment solution from 1.5 to 5.0 or 6.0, more desirably from about 2.0 to 4.0 or 5.0, and preferably from about 3.0 to 4.0. Generally lower pH values provide better ink coagulation (holdout), but some textile substrates (especially those with cotton fibers) are weakened by a pretreatment with lower pH values.

Other optional ingredients in the pretreatment solution may include, but are not limited to, humectants, surface tension modifiers, and biocides. Humectants are hydrophilic compounds that slow the evaporation of water from solutions during the final stages of film formation. Biocides prevent microbial degradation-their selection and use is generally well known in the art. Suitable humectants are the same as those suitable for use in colored inkjet inks.

The balance of the pretreatment solution is generally water and optionally up to 5 wt. % based on the weight of the pretreatment of low molecular weight alcohols such as methanol, ethanol, or propanol (like isopropanol) that promotes wetting of the fiber which leads to an even and thorough pretreatment distribution. In one embodiment a pretreatment solution can consist essentially of a nonionically stabilized polymer dispersion, a polyvalent water soluble metal cation, an optional surfactant, a coagulating acid, an optional crosslinking agent for the polymer, and an optional up to 5 wt. % alcohol.

### Polyurethane and Polyurethane Dispersions (PUD)

Polyurethane is a term used to describe polymers including oligomers (e.g., prepolymers) which contain the urethane group, i.e., —O—C(═O)—NH—, regardless of how they (urethane linkages) are made. As well known, these polyurethanes can contain additional groups such as urea, allophanatc, biuret, carbodiimidc, oxazolidinyl, isocynaurate, uretdione, ester, ether, carbonate, hydrocarbon, fluorocarbon, alcohol, mercaptan, amine, hydrazide, siloxane, silane, ketone, olefin, etc., in addition to urethane groups.

Aqueous describes a composition containing a substantial amount of water. Preferably aqueous will mean at least 20 wt. % water and in a more preferred embodiment it will be at least 50 wt. % water based on water and other solvents. It may contain other ingredients such as organic solvents as well. Thus, if we say aqueous polyurethane dispersion, we will mean in a preferred embodiment that the polyurethane is dispersed in a liquid media that is at least 20 wt. % water and can contain compatible organic materials such as alcohol and other polar organic solvents.

Polyurethanes of this invention are formed from at least one polyisocyanate and at least one NCO-reactive compound (also known as “active-hydrogen containing” compounds). Suitable polyisocyanates have an average of about two or more isocyanate groups, preferably an average of about two to about four isocyanate groups per molecule and include aliphatic, cycloaliphatic, araliphatic, aromatic, and heterocyclic polyisocyanates, as well as products of their oligomerization, used alone or in mixtures of two or more. Diisocyanates are more preferred.

### Active-Hydrogen Containing Compounds as Part of the Urethane

The term “active-hydrogen containing” refers to compounds that are a source of active hydrogen and can react with isocyanate groups via the following reaction:

—NCO+H—X→—NH—C(═O)—X

Such compounds typically range widely in molecular weight from 18 g/mol for water and 17 g/mol for ammonia to about 10,000 g/mol polyols. They are customary divided into two subclasses depending on their molecular weight: Polyols with number-average molecular weight from about 500 to 10,000 g/mol and chain extenders with molecular weight from 18 to 500 g/mol. The extremes of the scale represent physical reality: High-molecular-weight polyols contribute to the soft segment and short chain extenders contribute to the hard segment of polyurethane; however, the exact position of the divider is somewhat arbitrary and can be moved depending on the circumstances. Both classes are reviewed below in more detail.

The term “polyol” in the context of the present invention means any high molecular weight product (Mₙ>500 g/mol), typically referred to as a long-chain polyol, which has an active hydrogen that can be reacted with isocyanates and includes materials having an average of about two or more hydroxyl or other NCO-reactive groups per molecule. Such long-chain polyols include polyether, polyester, polycarbonate, and polycaprolactone polyols. Other examples include polyamide, polyester amide, polyacetal, polythioether, polysiloxane, ethoxylated polysiloxane, etc.

Chain extenders with the molecular weight from 18 to 500 g/mol such as aliphatic, cycloaliphatic or aromatic diols, amines, or mercaptans can be used during the formation of the prepolymer and during the dispersion step of the process.

### Water-Dispersibility Enhancing Compounds for the Polyurethanes

Polyurethanes are generally hydrophobic and not water-dispersible. Therefore, at least one water-dispersibility enhancing compound (i.e., monomer), which has at least one, hydrophilic, ionic or potentially ionic group is included in the polyurethane polymers and prepolymers of this invention to assist dispersion of the polymer/prepolymer in water.

These dispersibility enhancing compounds may be of a nonionic, anionic, cationic or zwitterionic nature or the combination thereof. Water-dispersibility enhancing compounds of particular interest are nonionic hydrophilic monomers. Some examples include alkylene oxide polymers and copolymers in which the alkylene oxide groups have from 2-10 and preferably 2-3 or 4 carbon atoms as shown, for example, in U.S. Pat. No. 6,897,281, the disclosure of which is incorporated herein by reference.

Solvents, which are nonreactive to any significant extent in the context of the urethane-making reactions, may be used in the present invention but are not preferred because they introduce volatile organic component (VOC).

### Optional Reactive Crosslinking Moiety

The coating composition may also include a latent reactive crosslinking component such as blocked isocyanates and/or 1,3-diketone functionality. The reactive crosslinking moiety includes 1,3-dicarbonyl compounds (also referred to as molecules containing 1,3-diketone functionality) such as esters of malonic acid and ketoximes such as butanone oxime. Polyurethane films are normally applied as a dispersion that easily forms a film at the temperature at which polyurethane is applied to a substrate and processed. After film formation it is sometimes desirable to crosslink or build the molecular weight of the polyurethane to provide barrier properties, enhanced tensile strength, or durability to the film. The reactive crosslinking moiety promotes or facilitates bonding of the urethane prepolymer to the various substrate(s). In the current disclosure it is desirable to provide enhanced wear resistance and wash-fastness in not only the pretreatment film but also any ink-jet ink or films applied to the pretreatment. While we use the term reactive crosslinking component we understand that the reactive crosslinking component can react with the surface of the substrate (providing bond strength to the substrate), and within the polymer or polyurethane of the pretreatment. Crosslinking within the pretreatment film provides a more durable pretreatment film. Bonding to a substrate provides a more durable composite image structure.

Plasticizers for the polymer binder of the pretreatment can be used. Plasticizers for various polymer binders are known and published in the literature.

Coalescents can be used in the polymer binder. There is some overlap in solvents, coalescents, humectants, and plasticizers. Coalescents tend to evaporate slower than water and remain with the polymer for an extended period of time facilitating film formation; in the end however, they eventually also migrate out of the final product.

Examples of coalescent include ethylene glycol mono 2-ethylhexyl ether (EEH), dipropylene glycol monobutyl ether (DPnB), ethylene glycol monobutyl ether acetate (EBA), diethylene glycol monobutyl ether (DB), ethylene glycol monobutyl ether (EB), dipropylene glycol monomethyl ether (DPM), diethylene glycol monomethyl ether (DM).

### Miscellaneous Additives

The pretreatment may contain a variety of additives to provide additional performance features or to accommodate an unusual substrate or unusual ink requirement. Such additives include surfactants, stabilizers, defoamers, antimicrobial agents, antioxidants, rheology modifiers and the like and the mixtures thereof. The use of such additives is well known to those skilled in the art.

### Auxiliary Additives

A specific subclass of additives preferred in the context of the present invention is auxiliary additives which enhance the performance of the pretreatment. These include pigments, mordants, cationic and nonionic surfactants, fixatives, and water soluble polymers.

For printing applications (such as ink jet printing), one or more inorganic or organic pigments and/or resin particles can be incorporated in order to provide the ink-receptive layer with improved ink absorbency, dye fixability, dye-color-producing ability, blocking resistance and water resistance. Such pigments include mineral or porous pigments: kaolin, delaminated kaolin, aluminum hydroxide, silica, diatomaceous earth, calcium carbonate, talc, titanium oxide, calcium sulfate, barium sulfate, zinc oxide, alumina, calcium silicate, magnesium silicate, colloidal silica, zeolite, bentonite, sericite and lithopone. As the above pigments can cause color variation between the pretreated areas and non-pretreated areas of a textile or garment, none of the pretreatments in the examples have pigments therein.

In addition, one or more of various other additives can also be incorporated in the pretreatment. These additives include thickening, parting, penetrating, wetting, thermal gelling, sizing, defoaming, antifoaming and blowing agents. Other additives include colorants, fluorescent whiteners, ultraviolet absorbers, oxidation inhibitors, quenchers, antiseptic agents, antistatic agents, crosslinking agents, dispersants, lubricants, plasticizers, pH adjusters, flow and leveling agents, setting promoters, and waterproofing agents.

In the pretreatment, one particularly preferred component is a surface active agent. This is typically a nonionic surfactant, anionic surfactant, or cationic surfactant. Surfactants (such as Byk™ 347 from Byk Chemie) can be used in the pretreatment at concentrations from about 0 to about 0.1 wt. % based on the weight of the pretreatment solution to ensure that surface tension of the pre-treatment in a range such that the pretreatment spread on the fabric.

Monohydric or polyhydric alcohols can be used in the pretreatment for a variety of effects including foaming control and further reducing the surface tension of the pretreatment. Preferred monohydric or polyhydric alcohols for this purpose include those with a molecular weight from about 32 to about 100 or 200 g/mole. Ethanol and isopropanol are preferred. These are typically used at concentrations from about 0, 0.1, or 0.5 to about 5 wt. % based on the weight of the pretreatment solution.

Blends with Other Polymers

The polymer binder dispersions of this invention can be combined with compatible polymers and polymer dispersions by methods well known to those skilled in the art. These include hybrid polymers of urethane polymers and acrylate type polymers derived from ethylenically unsaturated monomers and other free radically polymerizable monomers that can be polymerized by conventional free radical sources. Vinyl polymers is a generic term for polymers derived from substantial portions of unsaturated monomers or polymers derived from those monomers. Acrylic polymers (often considered a subset of vinyl) will refer to polymers derived from repeating units from acrylic acid, acrylates (being esters of acrylic acid), and alkacrylates such as methacrylates and ethacrylates and polymers therefrom. Additional free-radically polymerizable material (unsaturated monomers) may be added to the vinyl or acrylic monomers to copolymerize. It is anticipated that most of the monomers (e.g. >50 wt. %, more desirably >75 wt. % and preferably >85 wt. % of the total free-radically polymerizable monomers) will be vinyl or in narrower embodiments the acrylic monomers.

In one embodiment of hybrid polymers, the polymerization within the polyurethane particles can be done by forming the aqueous dispersions of polyurethane composite and then polymerizing additional monomers by emulsion or suspension polymerization in the presence of these dispersions. A way of making hybrid polymers is to include ethylenically unsaturated monomers in the polyurethane prepolymer (either with the reactants to form the prepolymer and/or any time before the urethane prepolymer is dispersed) and to cause these unsaturated monomers to polymerize before, during and/or after the prepolymer is dispersed in aqueous medium.

In one embodiment, the pretreatment solution of this invention typically has total solids (i.e., residues after oven drying at 105° C. for 1 hour) of at least about 4, 5 or 6 wt. % based on the weight of the pretreatment. Solids content and binder loading are a compromise of desiring high component loading and wanting good colloidal stability in the presence of polyvalent metal ions and an acid component. In one embodiment, the pretreatment solution will have total solids (as measured by drying a 1 gram sample to constant weight at 100° C.) of less than 25, 20, 15 wt. %. In one embodiment, the polymer/binder portion of the pretreatment solution will desirably be at least 1, 2, 3, or 4 wt. % of the solution. In one embodiment, the binder portion will be less than 25, 20, or 15 wt. % of the pretreatment solution. In one embodiment, the polymer of the nonionic polymer dispersion used as the binder will be between 11 and 15 wt. % of the pretreatment.

### Applications

The compositions of the present invention and their formulations are useful as pretreatments for textiles or garments to enhance digital image printing. In addition to textile fibers, the fibers can be specialty fibers. When we refer to the pretreatment on a textile or fabric as a coating, we mean that the pretreatment forms a partial and/or complete coating on the fibers or substrate and not necessarily an impervious film (more impervious films for liquids occur when coating smooth metal, plastic or wood). Pretreatments are often applied by spraying or padding. When the pretreatment is applied by padding, it may approach completely surrounding each fiber or group of fibers. The pretreatment may not completely cover each and every fiber when applied by spraying (especially fibers deep in the textile or cloth or in situations where fibers cross each other). Generally, on textiles and cloth, it is desired that the substrate after pretreatment is as porous to water or air as the untreated substrate.

In most commercial uses of fabric or garment pretreatments, the pretreatment would be applied to T-shirts with a DTG (direct to garment) pretreatment machine (DTG Pretreat-R Gen. II, such as sold by Colman and Company of Tampa, Fla.). In this type of commercial pretreatment equipment, the pretreatment solution is applied through an array of nozzles covering the width of the T-shirt. The T-shirt fabric generally is mounted on a stage. The stage moves past the nozzle array to expose the fabric to the pretreatment.

Preferred substrates for the pretreatment of this disclosure are garments or textiles for which some image (preferably digitally applied) is desired for labeling, decoration, advertising, etc. Preferred substrates are shirts with T-shirts and sport shirts being a suitable use. In one embodiment, woven or non-woven substrates are at least 25, 50 or 80 wt. % cotton, based on the weight of the fabric or substrate. In another embodiment, woven or non-woven substrates desirably have at least 25, 50, or 80 wt. % polyester based on the weight of the fabric or substrate. In one embodiment, the substrate can be a roll-to-roll textile, and in one embodiment a light colored or white roll-to-roll textile. In some applications, the substrate can be fiberglass and/or paper.

### Working Examples

In these examples, the following reagents were used:

BYK®-347—surfactant available from Byk Chemie in Europe
DeeFo® 97-3—defoamer from Ultra Additives
IPA—isopropyl alcohol

### Recipes for Pretreatment Compositions

### Procedure for Making Pretreatments

Nonionic polymers were generally diluted to between 5 and 10 wt. % solids before formulation. Some other components were also diluted if noted below. If diluted, the diluent was water unless otherwise specified. Typically, the acid component was added directly to the diluted nonionic polymer. Then one would add the metal salt directly to the mixture. Dilute IPA (50% in water used to promote spreading) was added if desired. Dilute Byk-347 (10% active in water) was added. The approximate total solids for most pretreatments is 13-21% and the total batch size for most pretreatments was approximately 400+/−10 g.

TABLE 1
Pretreatment Solutions

| | | | Control |
|---|---|---|---|
| | | | Commercial |
| | Inventive | Inventive | DTG |
| | Pretreatment | Pretreatment | Pretreatment, |
| | A, g | B, g | g |
| PrintRite ® DP760 | 5 | 9.75 | 0 |
| (nonionic acrylate | | | |
| polymer) | | | |
| Nonionically stabilized | 0 | 0 | N/A |
| polymer (believed to be | | | |
| ethylene-vinyl acetate | | | |
| copolymer) | | | |
| CaCl₂ or other divalent | 4.9 | 4.72 | N/A |
| metal | | | |
| Acid component such as | 2.4 | 0.3 | 0 |
| formic, citric, or AlCl₃ | | | |
| Alcohol such as methanol, | 0.91 | 0.52 | N/A |
| ethanol, or isopropanol | | | |
| BYK-347 | 0.03 | 0 | N/A |
| Water | Remainder | Remainder | Remainder |
| | to make 100 | to make 100 | to make 100 |

N/A means this information is not available

### Spraying Method for Applying Pretreatment

The pretreatment was applied to fabric pieces by a Wagner paint sprayer (or DTG Pretreat R Gen. II) to the prescribed amount in Table 2. The fabric sample was then dried and heated in a garment press (Insta™ Model #715 Cerritos, Calif.). When a pressure value is available for the drying step, a desired pressure is 40 pounds/in² (gauge). The pretreatment (both the inventive and control) were heated for 1 minutes at 107° C. to ensure that the pretreatment was dried. The ink image (on top of the pretreatment) for the inventive pretreatment based image was heated for 3 minutes at 107° C. after printing the ink image over the pretreatment. The ink image (on top of the pretreatment) for the control pretreatment based image was heated for 3 minutes at 160° C. after printing the ink image on the control pretreatment. Heating of the pretreatment is optional as long as the pretreatment is dried. Typically, a white ink is digitally applied only to the areas of the T-shirt where a colored image is to be applied. Some printers apply a thinner layer of white ink where a black or dark colored image is to be applied. Most printers digitally apply a heavier white ink layer where a light colored ink is going to be applied. Typically, the white ink is applied over the entire image area, allowed to air dry for a few seconds and then the colored ink is digitally applied in a separate step over the white ink. Heating between the white ink and the subsequent colored inks usually does not occur. Heating of the final printed image is desirable at it enhances fusion of the image particles to the substrate. Gauge pressures mean pressure above 15 psi of atmospheric pressure at sea level.

The pretreatment add-on percentage was determined by weighing the fabric before and after the pretreatment application by conditioning the fabric in a room with constant temperature/constant humidity (21° C. (70° F.), 50% relative humidity) overnight.

TABLE 2
Pretreatment Application Measurements for Inventive
Pretreatment and Control Pretreatment

| | Wet | | Wet |
|---|---|---|---|
| | Pretreatment, | Area in² | Pretreatment |
| Fabric | g | (m²) | g/in² |
| Polyester | 37.8 | 344 (0.222 m²) | 0.11 (170 g/m²) |
| Poly/Cotton | 37.8 | 344 (0.222 m²) | 0.11 (170 g/m²) |
| Blend | | | |

### Pigmented Ink Application

A DTG white ink (Genuine DTG Digital Ink: Bright V02 White) was digitally applied over the Control Pretreatment to the black dyed T-shirt polyester fabric using DTG machine printing as a first step. After the white digital ink was dried, DTG colored inks were printed using a DTG printer (DTG Digital Viper by Colman and Company). The white and colored inks used in the Control in the disclosure (whether applied manually or digitally) can be purchased over the internet from companies such as DuPont under its Artistri™ trade name, M&R Companies in Glen Ellyn, Ill., and marketers such as BelQuette, Inc. in Clearwater, Fla., Atlas Screen Supply Co. in Illinois, and Garment Printer Ink in New York, N.Y.

For the inventive pretreatment image the white and colored inks were formulated on site. The white and colored inks recommended by the vendor for use with the Control Pretreatment were known not to provide good color retention after washing unless cured at about 160° C. for about 3 minutes prior to washing. It was believed that curing at 160° C., while providing improved color retention during washing, resulted in dark dyes from the dark colored polyester fabric migrating into the printed image and reducing color intensity. The white and colored inks used with the inventive pretreatment comprised a urethane binder, anionically dispersed pigment, glycol or cyclic amide humectants, surfactants, biocide, and water as set forth in table 3.

A binder in the experimental inks in the form of a polymer dispersion in water is used to adhere the pigments securely to the pretreated substrate during washing Lubrijet™ T140 is a commercially available binder from The Lubrizol Corporation similar in properties to the experimental binder used to generate the data below. Desirable binders include those used in the art of textile printing such as, for example, vinyl acetate, acrylic, styrene acrylic, polyester and polyurethane binders. It is preferable that the polymeric binders are flexible and tough so that the resulting printed image can survive physical abrasion and stretching encountered in common use of the fabrics. It is desirable that the ink binder has a minimum film elongation to break greater than about 100% and more preferably greater than 400%. Useful binders preferably have tensile strengths greater than about 20 N/mm². If the ink binder is in a dispersed form in the ink composition, it is desirable that the average size of the binder particles is small and the distribution is narrow. Binder particles having mean sizes below about 150 or 100 nm and more preferably below about 50 nm are desirable. A preferred class of binders for use in pigmented inks are polyurethane binders. Polyurethane binders for pigmented inks having good flexibility, softness and toughness are exemplified by the aliphatic polyurethane Lubrijet™ T140. It is further contemplated that pigmented inks can comprise external crosslinking agents activated at 107° C. (if used with dyed dark colored polyesters) which can react with the ink binders in order to further improve the durability and adhesion of the printed image when used in combination with the fabric pretreatments of the present invention. Lubrijet™ T140 is an aliphatic TPU, has a volume average particle diameter size of <150 nm; a solids content about 40 wt. %; a pH of about 8; and a viscosity at 2 wt. % solids and at 25° C. of about 1.52 cps by TA DHR-Rheometer, 2 cone spindle with 40 mm in diameter, 50-1000 rpm; a Tg of −50° C., and a minimum film formation temperature of 5° C. Lubrijet™ T140 can be crosslinked with isocyanate or aziridine cross-linking agents.

An exemplary set of pigmented ink compositions were prepared using cyan (PB 15:3), magenta (PR122), yellow (PY155) and carbon black pigment (NIPex-180) as the pigment sources. The pigment dispersions were stabilized by means of anionically charged polymeric dispersant and mean particle sizes of the pigment particles were in the range of 50 to 160 nm known in the art of inkjet printing. Preferably, the stabilizing groups on the pigment particle or dispersant are anionic in nature although some nonionic stabilizers can be used. Anionic groups interact strongly with the inventive pretreatment compositions to limit the penetration of the ink particles through the treated fabric thereby delivering vibrant and washfast colors to the target fabric. A white ink was also prepared using titanium dioxide particles dispersed by means of a polymeric dispersant. Other typical pigmented ink sets used in digital printing will comprise a minimum of a cyan, magenta and yellow ink, and frequently also comprise a black or white ink. It is also contemplated to use additional colored pigmented inks in the ink set including, but not limited to; orange, green, blue, red and violet colored pigments. Cyan colored pigments are exemplified by copper phthalocyanine pigments, such as, CI PB 15:3 or 15:4. Magenta pigments are exemplified by quinacridones, such as, PR122, PR202, PV19 and solid solution mixtures of quinacridones. Yellow pigments are exemplified by any of the known yellow pigments in the art of inkjet printing, including, for example, PY74, PY110, PY83, PY138, PY155 and PY180. A particularly useful yellow pigment is PY155 due its good image fastness and low migration under high temperature curing conditions. Black pigments are typically carbon black and are exemplified by any of the pigments designated as PK-7, including, for example, NIPex-180, Cabot Black Pearls 880, Raven 3600, just to name a few. Colored pigment dispersions useful in the present invention include the Pro-Jet APD 1000™ series from FujiFilm Imaging Colorants.

Pigmented inks useful in the present invention also comprise one or more humectants which aid in the jetting and printing performance of the printing system. Humectants are typically water soluble organic compounds and can be selected from any of the well-known classes of materials including, for example; polyhydric alcohols and cyclic amides. Examples of humectants contemplated for use include, glycerine, ethylene glycol, propylene glycol, polyethylene glycols, polypropylene glycols, glycol ethers, 1,2-alkyldiols, alkyl diols, pyrrolidone, ureas, and the like.

Pigmented inks useful in the present invention also contain surfactants to aid in jetting of the pigment particles from the print-head and for interaction with the pretreated fabric. Any of the well-known surfactants in the art of inkjet printing can be contemplated for use and are preferably anionic or nonionic in nature. Surfactants useful in the pigmented inks include, but are not limited to, polysiloxanes (BYK™), acetylenediols (Surfynol™), ethoxylated alcohols (Tergitol™), fluorinated surfactants (Capstone™), and sulfonated, carboxylated or phosphonated surfactants. The level of the surfactant in the pigmented inks can be adjusted to provide good jetting properties through the target print head. Typical ink surface tensions range from about 20 to about 50 Dynes/cm, and more typically from about 25 to about 40 Dynes/cm. The amount of surfactant in the pigmented ink can be adjusted such that the desired surface tension range is met and also adjusted such the ink penetration is controlled on the pretreated fabric. This adjustment is done so that pigmented ink does not strike through the surface of the printed textile and transfer through to the backside of the fabric. Biocides can be used in the ink jet inks to prevent microbial growth during storage of the inks Biocides known to inhibit microbial growth in aqueous solutions are well known to the ink industry.

Isocyanate and/or aziridines crosslinkers can be used in combination with urethane binders. The amounts and types of isocyanate and aziridines crosslinkers are well known to the urethane art area. It would be desirable if crosslinkers used with dyed dark colored polyester fabrics had cure activation temperatures of 107° C. or less.

TABLE 3
Composition of White and Colored Inks Used with
Inventive Pretreatment

| | |
|---|---|
| Anionically dispersed Pigment (white | 3.5-4.5 wt. % |
| and other colors) | |
| Polyurethane Binder such as Lubrijet ™ | 3-11 wt. % |
| T140 from The Lubrizol Corporation | based on polymer |
| | solids |
| Glycol/cyclic amide humectants | 8-15 wt. % |
| Surfactants | 0.1-0.5 wt. % |
| Optional Crosslinker activated at 107° C. | 0.1-3 wt. % |
| or below | |
| Water | Balance to 100% |

### Washing Test

A GE Profile home laundry top loading washer (model #WPRE8100G) was used for the home laundering wash test. The settings were: hot wash and cold rinse, extra-large load and casual heavy wash. The fabric samples were put into the washer together with 5 standard-sized lab coats. A standard washing cycle (45 minutes at 56° C. (132° F.) was used to wash the fabric for 5 consecutive complete wash cycles. The detergent used was Tide liquid detergent at the recommended dosage per load. The five home launderings (i.e., the wet garments were rewashed four additional times) were followed by one single tumble dry cycle (on auto cycle permanent press) using a Whirlpool Cabrio dryer, Model # WED5500XWO.

The fabric that was printed with a layer of white ink and then with colored inks was cured following the same instructions as described in [0060]. The color values were measured on the colored blocks (CMYRBO) using the CIE 1976 L*, a*, b* color space scale a colorimetric meter made by X-Rite Gretagmacbeth (Model# Color i7). The fabric was then subjected to 5 home launderings and one dry cycle as described above and retested for color values after washing. This is a test of the image color retention after washing.

TABLE 4a
Colors Intensity of Images using Commercial (Market Control)
Pretreatment and Commercial Inks

| Market Control | | | | | |
|---|---|---|---|---|---|
| Pretreatment | | | | | |
| and | | | | | |
| Commercial | | Pre-wash | | Post-wash | |
| Inks | Color | x | y | x | y |
| | Red | 0.4481 | 0.3234 | 0.4237 | 0.3241 |
| | Orange | 0.4283 | 0.3926 | 0.4005 | 0.3854 |
| | Yellow | 0.4155 | 0.4603 | 0.3916 | 0.4268 |
| | Green | 0.3095 | 0.4074 | 0.3112 | 0.3828 |
| | Cyan | 0.2502 | 0.283 | 0.2744 | 0.3004 |
| | Blue | 0.2256 | 0.2379 | 0.245 | 0.2577 |
| | Magenta | 0.375 | 0.2509 | 0.357 | 0.2715 |
| | Red | 0.4481 | 0.3234 | 0.4237 | 0.3241 |

TABLE 4b
Colors Intensity of Images using Inventive Pretreatment A and
Experimental Inks according to Table 3

| Inventive | | | | | |
|---|---|---|---|---|---|
| Pretreatment | | | | | |
| and | | | | | |
| Experimental | | Pre-wash | | Post-wash | |
| Inks | Color | x | y | x | y |
| | Red | 0.4855 | 0.3279 | 0.4859 | 0.3257 |
| | Orange | 0.4633 | 0.4054 | 0.4606 | 0.4072 |
| | Yellow | 0.4353 | 0.4676 | 0.4334 | 0.4648 |
| | Green | 0.3277 | 0.4452 | 0.3264 | 0.4395 |
| | Cyan | 0.2557 | 0.2903 | 0.258 | 0.2916 |
| | Blue | 0.2192 | 0.2297 | 0.2177 | 0.2282 |
| | Magenta | 0.3985 | 0.2514 | 0.4011 | 0.251 |
| | Red | 0.4855 | 0.3279 | 0.4859 | 0.3257 |

The only difference between samples was the Market Control used a DTG pretreatment from Colman and Company of Tampa, Fla. using a nonionic binder (believed to be ethylene-vinyl acetate), CaCl₂, water, and a small amount of an alcohol and/or surfactant to modify the surface tension of the pretreatment. The Market Control was then digitally printed with DTG (direct to garment) white and colored inks also available from Colman and Company of Tampa, Fla. The Market Control image was cured at 160° C. as lower temperatures didn't give good wash stability to the final image. The Inventive Pretreatment samples were prepared on the same substrate (a dark polyester t-shirt) as the Market Control but the first Pretreatment A of Table 1 (based on 5 g of polymer from PrintRite® DP760) was used as the pretreatment and the digitally printed white and colored inks were formulated according to Table 3.

FIG. 1 shows the difference between color results on the Inventive Pretreatment and the Commercial Market Control Pretreatment after a variety of standard color inks were digitally applied to fabrics treated with Inventive Pretreatment or a Commercial Digital Pretreatment (Chromaticity Diagram) using the CIE 1976 L*, a*, b* color space scale a colorimetric meter as measured by an X-Rite Gretagmacbeth (Model# Color i7). Generally, the larger the area within the color diagrams the higher the color intensity. The x and y coordinates are hue and chroma. They can be measured directly with a Gretagmacbeth colorimetric meter.

While certain representative embodiments and details have been shown for the purpose of illustrating the subject invention, it will be apparent to those skilled in this art that various changes and modifications can be made therein without departing from the scope of the subject invention.

1. An aqueous substrate pretreatment comprising;
a) about 1 to about 20 or 30 wt. % of at least one synthetic polymer (e.g. a non-ionic acrylic, ethylene-vinyl acetate, urethane or mixtures thereof), in the form a nonionically stabilized aqueous polymer dispersion having colloidal stability in polyvalent metal ions, said wt. % based on the total weight of said pretreatment,
b) about 0.1 or 0.2 to about 15 wt. % of a water soluble polyvalent metal salt wherein said metal is selected from column 2-12 of the standard periodic table,
c) an organic and/or inorganic acid component in an amount from about 0.1 to about 10 wt. % based on the weight of the pretreatment, and used in an amount sufficient to adjust said aqueous pretreatment to a pH from 1.5 to 5.0,
d) optionally d1) mono or polyhydric alcohols and/or alkylene-oxide oligomers, and optionally d2) surfactant.

2. The aqueous substrate pretreatment material of claim 1, wherein said polyvalent metal salt is present from about 0.2 to about 10 wt. % and said metal is selected from the group consisting of salts of Ca²⁺, Mg²⁺, and Zn²⁺.

3. The aqueous substrate pretreatment material of claim 1, wherein said acid component comprises at least one acidic species selected from the group consisting of formic, acetic, oxalic, citric, tartaric, itaconic, phosphoric and selective Lewis acids selected from the group of AlCl₃, FeCl₃ and blends or derivatives thereof.

4. The substrate pretreatment material of claim 1, wherein said polymer having nonionic stabilization further comprises from about 0.1 to about 15 wt. % of side-chain hydrophilic oligomers of C₂-C₄ alkylene-oxides based on the polymer weight and/or sufficient polymer chains rich in acrylamide and/or methylol acrylamide to provide colloidal stability of a mixture of 10 wt. % polymer in 15 wt. % of calcium nitrate at ambient temperature (25° C.) after 24 hours as measure by more than 90 wt. % of the polymer remaining colloidally stable.

5. The aqueous substrate pretreatment material of claim 1, wherein the polymer is present from about 1 to about 20 wt. % based upon the weight of said aqueous pretreatment.

6. The aqueous substrate pretreatment material of claim 1, wherein said polymer is present from about 1 to about 15 wt. % based upon the weight of said aqueous pretreatment.

7. An aqueous substrate pretreatment material according to claim 1, wherein said substrate pretreatment is applied to a textile substrate at an level of about 0.04 to about 0.4 g of pretreatment per in² of textile substrate surface to be treated.

8. The aqueous substrate pretreatment material applied on a textile substrate according to claim 7, further comprising a printed image, wherein said printed image is derived from water based ink.

9. The aqueous substrate pretreatment material on a substrate according to claim 8, wherein said printed image is a digital image applied by ink jet printing.

10. The aqueous substrate pretreatment material on a substrate according to claim 7, wherein said pretreatment is heated to at least 94° C., and less than 150° C. for at least 3 minutes before the textile substrate is subjected to wash cycles.

11. The substrate pretreatment material on a textile substrate of claim 7, wherein said substrate in the form of a garment.

12. The aqueous substrate pretreatment on a substrate according to claim 7, wherein said substrate comprises at least 25 wt. % cotton.

13. The aqueous substrate pretreatment on a substrate according to claim 7, wherein said woven or nonwoven substrate comprises at least 25 wt. % polyester.

14. The aqueous substrate pretreatment coating on a substrate according to claim 7, wherein the pretreatment is applied to a cellulose based substrate.

15. A process for printing a woven or nonwoven substrate, comprising
a) supplying a textile substrate having a surface and fibers,
b) treating at least a portion of the surface of the substrate with the aqueous substrate pretreatment of any of claim 1 forming a pretreated substrate surface,
c) drying said aqueous substrate pretreatment of step b) to form a polymeric coating on said substrate or its fibers,
d) optionally heating said polymeric coating from 94 to 150° C.,
e) printing with a water based ink on said polymeric coating on said substrate or its fibers forming an image, and
f) optionally heating said image from 94 to 150° C.

16. The process according to claim 15, wherein said woven or nonwoven substrate is a textile and wherein said step of optionally heating said image is mandatory and said heating step is from 94 to 150° C.

17. The process according to claim 15, wherein said step heating step of said polymeric coating is at a temperature from 100° C. to 120° C. and the time of exposure is from 5 seconds to 5 minutes after said polymeric coating and substrate are in dry form.

18. The process according to claim 15, wherein said printing step includes ink jet printing on said substrate and over said pretreatment.

19. The process according to claim 15, wherein said printing step includes ink jet printing a white ink on said substrate over said pretreatment and forming a light reflective surface with high whiteness on said substrate and subsequently ink jet printing a non-white color onto said light reflective surface on said substrate.

20. The process according to claim 19, further comprising a step of printing a non-white color onto said light reflective surface of said substrate and heating said non-white color to a temperature of at least 100° C.

21. The process according to claim 15, where said printing step is via flexo, roto gravure, offset, or screen printing methods.
